(19) United States
(12) Patent Application Publication
(10) Pub. No.: US 2009/0125464 A1
(43) Pub. Date: May 14, 2009

(54) Method and Apparatus for Acquiring a Common Interest-Degree of a User Group

(75) Inventor: Xiaowei Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,380

(22) PCT Filed: Jan. 13, 2006
(86) PCT No.: PCT/IB06/50120

§ 371 Date: Jul. 20, 2007

(30) Foreign Application Priority Data
Jan. 21, 2005 (CN) 200510006216.X

(51) Int. Cl. G06F 15/18

(52) U.S. Cl. 706/14

(57) ABSTRACT

A method of acquiring a common interest-degree of a user group for a program, wherein each user of the user group corresponds to a user profile, and the method includes the following steps: receiving a program, which contains at least one content feature; acquiring like-degree, compromise-index and user weight of the user for the said content feature from the user profile; adjusting the user's like-degree for the content feature, with combination of user weight and comprise-degree of each user; acquiring the common interest-degree of the user group for the program according to the adjusted like-degree. In this invention, the compromise indexes of the various users, who are watching certain program, are adopted to adjust the corresponding user weights, so as to acquire the common interest-degree of the user group more accurately and comprehensively.

### FIELD OF THE INVENTION

This invention relates to a method and means for acquiring user's interest-degree, in particular to a method and means for acquiring the common interest-degree of a user group, and the method and means for recommending information to the user group according to the common interest-degree.

### BACKGROUND OF THE INVENTION

With the development of modern communication technology, people have access to abundant information at any time. However, the sudden flood of information makes people feel at lost from time to time. People are in the desperate need of an apparatus for acquiring user's interest-degree, to recommend the users the information they are interested in.

At present, the method and apparatus of acquiring user's interest-degree is usually used to acquire the interest-degree of one single user for a program; while there are not many methods and apparatuses available of acquiring the common interest-degree of a user group (which contains at least two users) for a program.

But, within a family or a dormitory there is usually a user group, who quite often watch programs together. For instance, there is a family of a father, a mother and a child. Each one of them has their own interest-degree. When it comes to watching TV together, it is unavoidable that they argue over who should take the remote controller and decide what to watch. Therefore, there should be a method and apparatus for acquiring the common interest-degree of a user group, so as to recommend them those programs which are interesting to all of them.

The present method of acquiring the common interest-degree of a user group for a program is achieved through adjusting the relevant like-degree according to the user weight of each user in the user group.

The user weight refers to the importance of each user in the user group, where some users are more dominant than others, therefore the weights thereof are bigger; while some users are less dominant and the weights thereof are smaller.

For example, the international patent application, No. PCT/IB02/01034 (the applicant is KONINKIJKE PHILIPS ELECTRONICS N.V., and International Application Date is Mar. 28, 2002, Prior Date is Mar. 28, 2001) introduces above method of acquiring the common interest-degree of a user group for a program through adjusting the like-degree according to the said user weight.

However, in the said international patent application, each user weight according to which each user adjusts the like-degree for all programs is the same, despite of the influence of the team spirit of each user in the user group on the corresponding user weight with respect to the difference of various programs. The team spirit refers to the compromise every user (or all the users) in the user group is willing to make under the influence of the team spirit for certain program, thus decides whether he/she is going to watch the program with other users in the group or not.

In summary, the present method for acquiring the common interest-degree of a user group for a program, through adjusting the like-degree for the program according to the fixed user weight of each user in the user group cannot acquire the common interest-degree of the user group for the program accurately and comprehensively.

Therefore, this invention introduces a method and apparatus for acquiring the common interest-degree of a user group, so as to recommend those information which are interesting to all of them more comprehensively and accurately.

### OBJECT AND SUMMARY OF THE INVENTION

One object of this invention is to acquire a common interest-degree of a user group for a program more accurately, so as to recommend those programs, which are interesting to all of them more accordingly.

One aspect of this invention is to provide a method for acquiring the common interest-degree of a user group for a program, each user of the group corresponding to a user profile, which comprises the following steps: receiving a program, which contains at least one content feature; acquiring the like-degree, compromise index and user weight of said each user for said content feature from said user profile of the user; adjusting the user's like-degree of each user for said content feature in combination with the user weight and compromise index; and acquiring the common interest-degree of the user group for the program according to the adjusted like-degree.

In an embodiment of this invention, said compromise index is used to indicate the attitude of each user in said user group taken against the content feature, which includes compromise, non-compromise and indifference, for the whole interest of the user group.

In another embodiment of this invention, said adjusting process in combination with the compromise index and the user weight further comprises the following steps: Adjusting the user weight, according to said compromise index so as to acquire the adjusted user weight; and Adjusting said like-degree according to said adjusted user weight, so as to acquire the like-degree of each user for said content feature after said adjustment.

In this invention, the compromise indexes of various users in the user group shall be used to adjust the relevant user weights. It is not only that, the team spirit (the compromise index of various users in the user group) of various users in the group has been taken into consideration, but also that, when not whole initial user group is watching a program, the user weights of the users, who are watching the program, are re-distributed, so as to acquire the common interest-degree of the user group more accurately and comprehensively.

Another aspect of this invention is to provide a method for recommending program to a user group, each user thereof corresponding to a user profile, which comprises the following steps: receiving a program, which contains at least one content feature; acquiring the like-degree, compromise index and user weight of the user for said content feature from said user profile of each user; adjusting the user's like-degree for said content feature in combination with the user weight and compromise index of each user; acquiring the common interest-degree of the user group for the program according to the adjusted like-degree; and deciding whether to recommend the program to the user group, according to the common interest-degree of the user group for the program.

In an embodiment of this invention, the compromise index is used to indicate the attitude of each user in said user group taken against the content feature, which includes compromise, non-compromise and indifference, for the whole interest of the user group.

In another embodiment of this invention, said adjusting process in combination with the compromise index and the user weight further comprises the following steps: adjusting said user weight, according to said compromise index so as to acquire the adjusted user weight; and adjusting said like-degree according to said adjusted user weight, so as to acquire the like-degree of each user for said content feature after said adjustment.

Another aspect of this invention is to provide an apparatus for acquiring the common interest-degree of a user group for a program, each user in the user group corresponding to a user profile. The apparatus comprises: receiving means for receiving a program, which contains at least one content feature; acquiring means for acquiring the like-degree, compromise index and user weight of said each user for said content feature from the user profile of the user; adjusting means for adjusting the like-degree of the user for said content feature in combination with the user weight and compromise index of each user; and common interest-degree analyzing means, for acquiring the common interest-degree of the user group for the program according to the adjusted like-degree.

In an embodiment of this invention, the adjusting means further comprises: first-adjusting means for adjusting said user weight according to said compromise index so as to acquire the adjusted user weight; and second-adjusting means for adjusting said like-degree according to the adjusted weight, so as to acquire the like-degree of each user for said content feature after said adjustment.

Another aspect of this invention is to provide an apparatus for recommending information to a user group, in which group each user corresponds to a user profile. The apparatus comprises: receiving means for receiving a program, which contains at least one content feature; acquiring means for acquiring the like-degree, compromise index and user weight of said each user for said content feature from the user profile of the user; adjusting means for adjusting the like-degree of the user for said content feature, in combination with the user weight and compromise index of each user; and common interest-degree analyzing means, for acquiring the common interest-degree of the user group for the program according to the adjusted like-degree; recommending means for deciding whether to recommend the common interest-degree of the user group for the program.

In an embodiment of this invention, the adjusting means further comprises: first-adjusting means for adjusting said user weight according to said compromise index, so as to acquire the adjusted user weight; and second-adjusting means for adjusting said like-degree according to said adjusted user weight so as to acquire the adjusted like-degree of each user for the content feature after said adjustment.

By referring to the descriptions and the claims together with the figures attached, it is obvious to learn the other purposes and achievements of this invention, and it will help to understand this invention more comprehensively.

### BRIEF DESCRIPTION OF THE DRAWINGS

The explanation to this invention is detailed in the following embodiment together with the accompanying figures, in which:

FIG. 1 is the structure diagram of an information recommendation system in accordance with an embodiment of this invention;

FIG. 2 is the workflow diagram of an information recommendation method in accordance to an embodiment of this invention.

Through all the figures, same reference number refers to identical or similar features and functions.

### DETAILED DESCRIPTION OF THE INVENTION

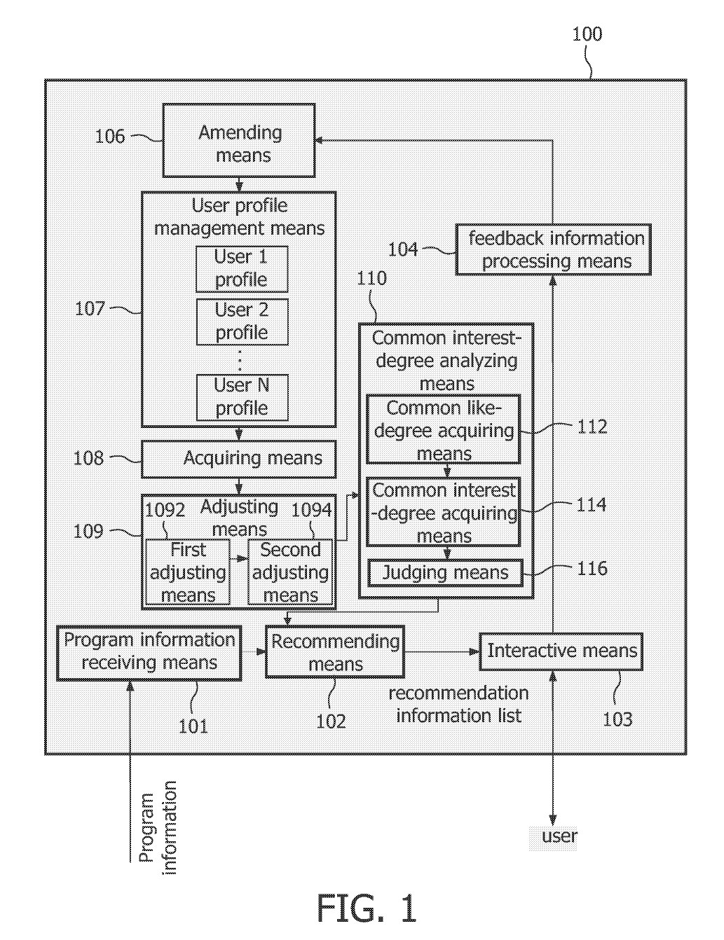

FIG. 1 is the structure diagram of an information recommendation system in accordance with an embodiment of this invention.

System 100 comprises user profile management means 107, acquiring means 108, an adjusting means 109 and common interest-degree analyzing means 110.

The user profile management means 107 are used to manage the user profile of each user in an initial user group, which consist of at least two users, for instance, user 1 profile, user 2 profile and user N profile. Each user profile comprises the interest reaction of the user towards one or more content features, for example, the like-degree, compromise index and user weight. Of course, it may also to put the interest reactions of all the users in an initial user group into one general user profile, or, divide the initial user group into several subgroups, each corresponding to a divided user profile. Of course, it is also possible to set the like-degree, compromise index and user weight of each user for a certain program directly.

In this embodiment, one user corresponds to one user profile, each user profile comprising the like-degrees, compromise indexes and user weights of the user for various content features.

The initial user group described above refers to the total number of the users in the group when the user profile is initialized, which contains at least two users. However, the typical user group refers to the user group which is watching a program (or the one is listening to a program, or the one is using the product/content. This embodiment hereafter refers to the TV program). For example, an initial user group includes 5 users, but the user group that watches the program is not always of 5 users. Sometimes, there might be 3 users, sometimes 4 or 2 etc. But, a user group contains at least 2 users.

The content features refers to the actors (for example, Fan Bingbing, Ge You, etc.); program genres (cartoon, story, romance and military film) and directors (Zhang Yimou, Feng Xiaogang, etc.) contained in the program. These content features may come from radio, TV, Internet or other information source. The most typical practice is that the content features are sent to users through digital television Electronic Program Guide (EPG).

The content feature in the user profile can be a single one, for instance, only a particular actor. Of course, the user profile can also contain many content features, which make the corresponding recommendation result more accurate.

The like-degree refers to the user's feeling to various content features, which can be represented by a scale, for example, [0, 100] pre-set by the user.

The compromise index are used to indicate that, for the sake of the whole interest of the initial user group, the attitude of each user in the initial group for every content feature is taken to reflect the team spirit of each user in the initial group. For certain content feature, some of the users are willing to make compromise with the other users to watch the program with the content feature together; while for another content feature, these users are not willing to watch program with another content feature together with the other users in the group.

The compromise index can be pre-set by each user and can be amended at their wills at any time, or can be set by the system automatically and amended according to the history information amendment of the program user watched. For example, the compromise index is one value in [0,1,2], in which 0 means compromise, 1 means indifference, 2 means non-compromise. Of course, the compromise index can also be set as a scale, like [0, 2] and etc. For different content features, each user may set a different value in the scale.

The user weight refers to the importance of each user in the initial user group. Some users are more dominant and user weights thereof are higher; while others might not be that dominant, and the weights thereof are lower. The user weight of each user is pre-set through common discussions of each user within the user group, which can be amended later again through common discussions.

Of course, the user weight does not necessarily have to be amended. It is because that, the user weight in this embodiment will vary according the adjustment of the compromise index. Each user's compromise index for different content features may be various, and may be amended by the user all the times, which can also response to the variation of the relevant user weight.

In the initial user group, the total sum of all the user weights is 1, the total sum of the user weights of the various users who are watching TV in the user group after being adjusted by the compromise indexes is still 1.

The user profile can be set and initialized by the user himself, which of course, is not the only way. There are other ways available to acquire the user profile. For example, the producer can initialize the user profile of the recommendation system according to the user's basic information (e.g. gender, age, etc).

The acquiring means 108 are used to acquire the information such as like-degree, compromise index and user weight etc. of each user in the user group for various content features from the user profile management means 107.

The adjusting means 109 are used to adjust the corresponding acquired like-degree according to the acquired user weight and compromise index as described above.

The adjusting means 109 comprise first adjusting means 1092 and second adjusting means 1094. The first adjusting means 1092 are to adjust the user weight according to the compromise index; while the second adjusting means 1094 is to adjust the relevant like-degree according to the user weight which has been adjusted by the compromise index.

The common interest-degree analyzing means 110 are used to acquire the common interest-degree of the user group for a program according to the adjusted like-degree as described above, and to judge if the common interest-degree is bigger than a threshold. The threshold can be pre-set by the user group, for instance, as 60.

The common interest-degree analyzing means 110 comprise common like-degree acquiring means 112, common interest-degree acquiring means 114 and a judging means 116.

The common like-degree acquiring means 112 are used to acquire the common like-degree of the user group for every content feature. The total sum of the adjusted like-degree of the user group for every content feature can be used as the common like-degree of the user group for the content feature.

The common interest-degree acquiring means 114 are used to acquire the common interest-degree of the user group for the program according to the common like-degree of the user group for all the content features of a program. Usually, the average of the common like-degree of the user group for all the content features in the program are used as the common interest-degree of the user group for the program.

Of course, if there is only one content feature in the program, then there is no need to acquire the average of the common like-degree of the user group for all the content features in the program, but to use common like-degree of the user group for that content feature as the common interest-degree of the group for the program directly.

The user profile of this embodiment can only comprise a content weight, which refers to, when the user is selecting programs, the influence of the various content features, like actors, directors and genres on the choice made. In other word, it also refers to the criteria the user adopts, when choosing his favorite program, which may be based on the actors, genres or directors. Among all the criteria, the content weights for all the actors might be the same, or are the content weights for all the genres, or otherwise are the content weights for all the directors. The content weights can also be pre-set within a scale, for example [0, 50], by the supplier.

In this embodiment, the common interest-degree of the user group can also be obtained through the combination of the said content weight and like-degree.

The judging means 116 are used to judge whether the common interest-degree of the user group acquired for said program is bigger than the said threshold. If it is bigger than the threshold, then the program should be recommended to the user group; if it is smaller than or equal to the threshold, then the program shall not be recommended to the user group.

The system 100 comprises program information receiving means 101, recommending means 102, interactive means 103, feedback information processing means 104 and amending means 106.

The program information receiving means 101 are used to receive program information and digital television Electronic Program Guide (EPG) corresponding to the program and etc.

The recommending means 102 are used to provide a recommendation list to the user group, according to the program information received and the analyzing result of the common interest-degree degree analyzing means 110. The list comprises the programs that might be interesting to the user group.

The interactive means 103 are used to demonstrate the program or recommendation list to the users, and also receive the feedback information, for example, selecting to watch a recommended program or not watch it; how long the program has been watched and the like-degree, compromise index for the program or content features and amending the user weight etc. from the user regarding the program recommended or the program watched.

Of course, the interactive means 103 can also be used to receive the information of the users in the group, who are watching the program. For example, the users input the user information of those who are watching TV into the interactive means 103 through remote controller or camera (not shown in the figures). The system 100 then knows which users in the initial group are watching TV, namely determining the user group who are watching TV at the moment, so as to recommend the programs, which are interesting to all of them, to the user group.

The feedback information processing means 104 are used to process the feedback information from the user received by the interactive means 103, so as to find out the interest change of each user.

The amending means 106 is used to amend the information in each user's profile according to the interest change thereof.

The user profile management means 107 in the said system 100 can be a storage (a hard disk, for example), while the rest of the means can be operated under the support of a central processing unit (CPU).

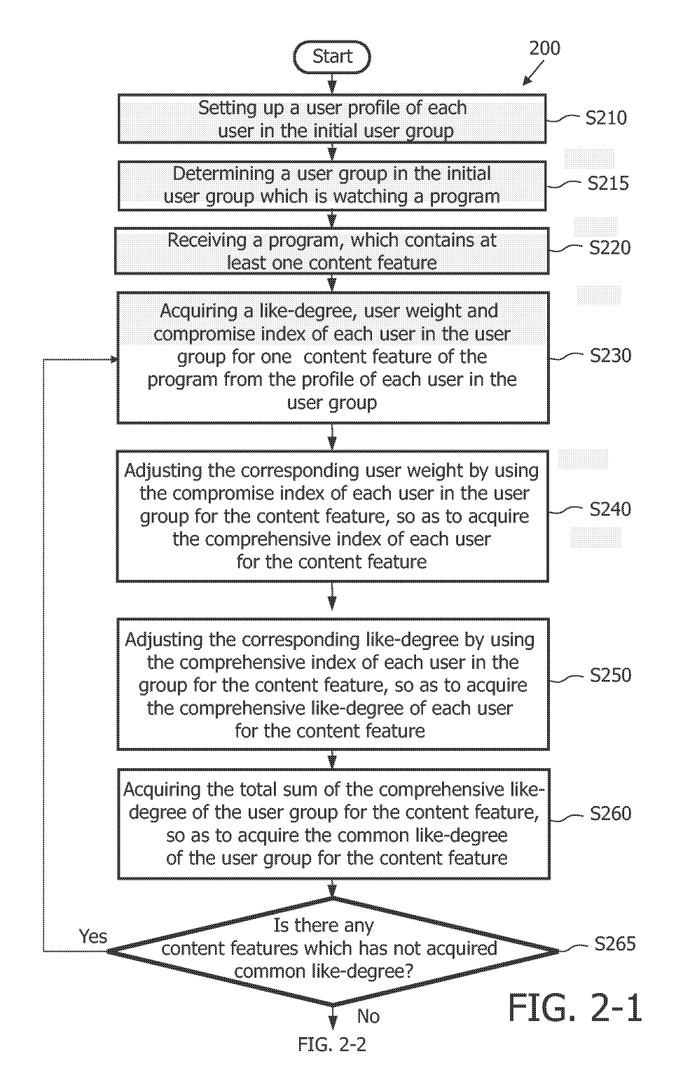

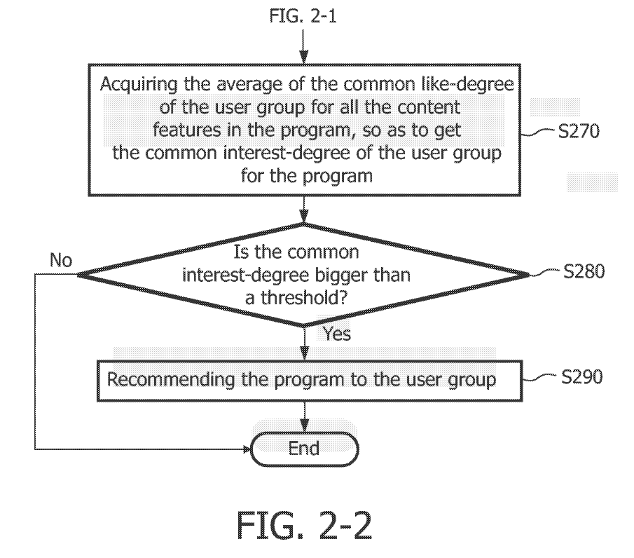

FIG. 2 is the workflow diagram of an information recommendation method in accordance with an embodiment of the present invention. The program hereafter can be video program or audio program, products, contents and etc. The explanation hereafter refers to a video program.

Firstly, setting up the user profile of each user in the initial user group (step S210). Each user profile contains the like-degree, compromise index and user weight of the user for at least one content feature. Of course, if each user profile in the initial user group exists, and said step can be omitted. Of course, the like-degree, compromise index and user weight for the program of each user can be pre-set directly.

In this embodiment, one user corresponds to one user profile, each user profile contains like-degree, compromise index and user weight of the user for at least one content feature.

The said initial user group refers to the total number of the users in the group, when the user profile is initialized, which contains at least two users. Generally speaking, the user group refers to the group which is watching a program. For example, an initial user group includes 5 users, the user group that watches the program is not always of 5 users. Sometimes, there might be 3 users, sometimes 4 or 2 etc. But, a user group contains at least 2 users.

There might be only one content in the user profile, for instance, a certain actor. Of course, there might be several content features in the profile. At this time, the recommendation result will be more accurate.

In the said user profile of each user, if there are a series of content features, which further contains a quaternary array (Content feature, Like-Degree, Compromise index, Individual weight). Accordingly, the user profile (UP for short) can be expressed by a vector of a quaternary array (t, ld, ci, iw). If there are altogether m different content features, the interest of user j among n users for these content features can be expresses as:

UPⱼ=((t₁,ld₁,ci₁,iwⱼ),(t₂,ld₂,si₂,iwⱼ) . . . (tᵢ,ldᵢ,ciᵢ,iwⱼ) . . . , (tₘ,ldₘ,ciₘ,iwⱼ)) (1)

Here, tᵢ is a content feature; i is the serial number for the content feature tᵢ; while ldᵢ is the like-degree for the content feature tᵢ; ciᵢ is the compromise index of the user j for the content feature tᵢ; and iwⱼ is the user weight of the user j.

For example, assuming the scale of the like-degree in the user profile is [1, 100]; the compromise index is [0, 1, 2], in which “0” means compromise, “1” means indifference, “2” means non-compromise; while the total sum of all the user weights is 1.

The total sum of all the user weights in an initial user group cannot exceed 100%. For example, there is an initial user group comprises 4 users, namely a father, a mother, a son and a daughter. Their weights are 30%, 30%, 20% and 20% respectively, and the total sum is 100%.

In the said initial user group with a father, a mother, a son and a daughter, each user's user profile contains the interest reaction towards the content features: actor A and military movie:

### Father:

Actor A: ld=90; ci=2; iw=30% (Actor A, 60, 1, 30%)

Military Movie: ld=70; ci=1; iw=20% (Military Movie, 90, 2, 30%)

### Mother:

Actor A: ld=30; ci=1; iw=0.3 (Actor A, 80, 0, 30%)

Military Movie: ci=0; ld=20; iw=0.3 (Military Movie, 30, 0, 30%)

### Son:

Actor A: ld=30; ci=1; iw=0.3 (Actor A, 50, 1, 20%)

Military Movie: ci=0; ld=20; iw=0.3 (Military Movie, 70, 1, 20%)

### Daughter:

Actor A: ld=30; ci=1; iw=0.3 (Actor A, 90, 1, 30%)

Military Movie: ci=0; ld=20; iw=0.3 (Military Movie, 70, 0, 20%)

If the user has not set the quaternary array for certain content feature, then it will be taken for granted that ld=0, ci=0, and iw is the same iw of the user for other content feature.

For the interest reaction of n users for the m content feature, it can be expressed by the table below:

| | iw | | | | |
|---|---|---|---|---|---|
| | iw(1) | . . . | iw(j) | . . . | iw(n) |
| fn | ld ci | | | | |
| feature(1) | ld(11) | . . . | ld(j1) | . . . | ld(n1) |
| | ci(11) | | ci(j1) | | ci(n1) |
| . . . | . . . | . . . | . . . | . . . | . . . |
| feature(i) | ld(1i) | . . . | ld(ji) | . . . | ld(ni) |
| | ci(1i) | | ci(ji) | | ci(ni) |
| . . . | . . . | . . . | . . . | . . . | . . . |
| feature(m) | ld(1m) | . . . | ld(jm) | . . . | ld(nm) |
| | ci(1m) | | ci(jm) | | ci(nm) |

Secondly, determining users in the initial user group who are watching a program (step S215), which can be acquired through components like remote controller or camera (not shown in the figures).

As aforementioned, in the initial group with a father, a mother, a son and a daughter, at present there is a group with only 3 users, the father, the mother and the son, who are watching the program.

Thirdly, receiving a program (step S220), which contains at least one content feature. For instance, the content feature concerns to the content feature of the program genre, such as military movie.

Fourthly, acquiring the like-degree, compromise index and user weight of each user in the user group for one content feature of the program from the profile of each user in the user group (step S230).

For example, in the group with the father, the mother and the son which is watching the program. Their interest-degree towards the content feature 1, the military movie, can be expressed as the table 1 below:

TABLE 1

| | USER | | |
|---|---|---|---|
| Class | FATHER | MOTHER | SON |
| User Weight | 30% | 30% | 20% |
| Like-Degree | 90 | 40 | 70 |
| Compromise Standard | 2 | 0 | 1 |

Fifthly, the corresponding user weight by using the compromise index of each user in the user group for the content feature shall be processed, so as to acquire the comprehensive index of each user for the content feature (step S240).

Specifically, this step can be accomplished trough the following three procedures:

(1) Firstly, multiply the compromise index of each user for the content feature with the corresponding user weight, Father: 30%*2=60%; Mother 30%*0=0; Son 20%*1=20%.

(2) Secondly, derive the sum after the multiplying: 60%+0+20%+0=80%

(3) Divide the user weight of each user after the multiplying by the said sum, so as to find out the adjusted user weights respectively, namely the said comprehensive index:

Father's user weight becomes to 60%/80%=75%; Mother's user weight becomes to 0/80%=0; Son's user weight becomes to 20%/80%=25%.

The like-degree, compromise index and the said comprehensive index of the aforementioned users for the military movie can also be expressed as in the Table 2 below:

TABLE 2

| | User | | |
|---|---|---|---|
| Class | Father | Mother | Son |
| Comprehensive Index | 75% | 0 | 25% |
| Like-degree | 90 | 40 | 70 |
| Compromise Index | 2 | 0 | 1 |

The total sum of the comprehensive indexes of all the users in Table 2, namely the total sum of all the adjusted user weights, still equals to 1. The user weights of those who are watching the program at the present have been re-distributed.

Through the said adjustment, it is not only that, the team spirit (the compromise index of various users in the user group) of various users in the user group has been taken into consideration, but also that, when not the whole initial user group is watching a program, the weights of the users, who are watching the program, are re-distributed, so as to acquire the common interest-degree of the group more accurately and comprehensively.

Sixthly, according to the comprehensive index of each user in the user group for the content feature, the corresponding like-degree shall be adjusted, so as to acquire the comprehensive like-degree of each user for the content feature (Step S250).

Through this process, multiply said comprehensive indexes and the corresponding like-degree, so as to acquire the comprehensive like-degree of each user for the military movie, which is shown in Table 3 below:

TABLE 3

| | User | | |
|---|---|---|---|
| Class | Father | Mother | Son |
| Comprehensive Index | 75% | 0 | 25% |
| Comprehensive Like-degree | 90*75% = 67.5 | 40*0 = 0 | 70*25% = 17.5 |
| Compromise Standard | 2 | 0 | 1 |

Seventhly, acquire the total sum of the comprehensive like-degree of the user group for the content feature, so as to acquire the common like-degree of the user group for the content feature. (Step S260).

Usually, the said step is to add up the comprehensive like-degree of various users for this military movie in Table 3, for instance, 67.5+17.5=85, namely the common like-degree of the user group for the content feature is 85.

Eighthly, judging if there are any other content features in the program, the common like-degree of the user group for which has not been acquired (Step S265).

Through the said judging process, if there are content features, for which the common like-degree is still not acquired, return to step S230 and repeat the afro-mentioned steps.

Through the said judging process, if there are no other content features, the average of the common like-degree of the user group for all the content features shall be acquired, so as to acquire the common interest-degree of the user group for the program (Step S270). Of course, if there is only one content feature, it is unnecessary to acquire the average value.

For example, the said program contains two content features, one is Military Movie, another is Actor A. The common like-degree of the user group for Military Movie of the programs 85, while that for Actor A is 56 (The detailed calculation process shall be omitted here, which is the same as the calculation process of the Military Movie). Therefore, the common interest-degree of the user group for the program is Eighthly, judging if the acquired common interest-degree of the user group for the program described above is bigger than a threshold (Step S280).

The threshold can be pre-set by the initial user group, for instance, as 60.

Through said judging process, if the common interest-degree of the user for the program is bigger than a threshold, then the program shall be recommended to the user group (Step S290). After that, the whole recommendation process shall be concluded.

In the above example, the common interest-degree of the user group for the program is 70.5>60, therefore the program should be recommended to the user group.

Of course, through the judging process, if the common interest-degree of the user group for the program is not bigger than the threshold, then the whole process shall be concluded directly, and the program shall not be recommended to the user group.

In this embodiment, the compromise indexes of the various users in the user group shall be used to adjust the corresponding user weights. It is not only that, the team spirit (the compromise index of various users in the user group) of various users in the user group has been taken into consideration, but also that, when not the whole initial user group is watching a program, the weights of the users, who are watching the program, are re-distributed, so as to acquire the common interest-degree more accurately and comprehensively for the user group.

In the embodiment, it is after acquiring the comprehensive like-degree of each user in the user group for every content feature in a program, that the total sum of the comprehensive like-degree of the user group for the content feature is acquired, so as to find out the common like-degree of the group for the content feature; finally the average of the common like-degree of the user group for all the content features in the program is acquired, so as to find out the common interest-degree of the user group for the program. Of course, if there is only one content feature in the embodiment, then it is unnecessary to find out the average value thereof.

Of course, the common interest-degree of the user group for a program can also be acquired through the following order: after acquiring the comprehensive like-degree of each user in the user group for every content feature in a program; the average of the comprehensive like-degree of each user in the user group for all the content features in the program shall be acquired (if there is only one content feature, then it unnecessary to go through the averaging process), so as to find out the personal interest-degree of each user for the program; finally, the total sum of the interest-degree of each user in the user group for the program shall be acquired so as to find out the common interest-degree of the user group for the program.

In the user profile in this invention, the compromise index and the user weight can be replaced by the said comprehensive indexes, which can be pre-set by the initial user group and amended at any time by consulting, and then adjusted by the system automatically, so as to ensure the total value of the comprehensive indexes of the user group, which is watching the program, is 1.

The above mentioned user profile in this invention can also comprise a content weight, which refers to, when the user is selecting programs, the influence of the various content features, like actors, directors and genres on the choice made. In other word, it also refers to the criteria the user adopts, when selecting his favorite program, which may be based on the actors, genres or directors. Among all the criteria, the content weights for all the actors might be the same, or are the content weights for all the genres, or otherwise are the content weights for all the directors. The content weights can also be reflected by a scale, for example [0, 50], pre-set by the supplier.

This invention, when combined with compromise index and user weight, can be used to adjust the content weight of the user group for the content features. The process is the same as the above mentioned process of adjusting the like-degree. It is then combined with the content weight and like-degree so as to find out the common interest-degree of the user group for certain program.

The method introduced in this invention to acquire the common interest-degree of the user group is also applicable to other programs, products and contents.

Although much has been said to explain this invention in reference to the embodiments, for those skilled in the art, it is obvious for them to make replacements, modifications and variations according to the description above. Therefore, when such replacements, modifications and variations are within the spirit and scope of the attached claims, they are also included in this invention as well.

1. A method for acquiring a common interest-degree of a user group for a program, each user of the user group corresponding to a user profile, which method comprises the following steps:
(a) receiving a program, which contains at least one content feature;
(b) acquiring a like-degree, compromise index and user weight of the user for said content feature from said user profile of each user;
(c) adjusting the user's like-degree for said content feature in combination with the user weight and compromise index of each user; and
(d) acquiring the common interest-degree of the user group for the program according to the adjusted like-degree.

2. The method as claimed in claim 1, wherein said compromise index is used to indicate the attitude of each user in said user group taken against the content feature for the whole interest of the user group, which attitude includes compromise, non-compromise and indifference.

3. The method as claimed in claim 1, wherein said user weight is used to indicate the importance of each user in the user group.

4. The method as claimed in claim 1, wherein the step (c) includes the following steps:
(c1) adjusting said user weight, according to said compromise index so as to acquire the adjusted user weight; and
(c2) adjusting said like-degree according to said adjusted user weight, so as to acquire the like-degree of each user for said content feature after said adjustment.

5. A method for recommending program to a user group, each user of the group corresponding to a user profile, which method comprises the following steps:
(a) receiving a program, which contains at least one content feature;
(b) acquiring a like-degree, compromise index and user weight of the user for said content feature from said user profile of each user;
(c) adjusting the user's like-degree for said content feature in combination with the user weight and compromise index of each user;
(d) acquiring a common interest-degree of the user group for the program according to the adjusted like-degree; and
(e) deciding whether to recommend the program to the user group according to the common interest-degree of the user group for the program.

6. The method as claimed in claim 5, wherein the said compromise index is used to indicate the attitude of each user in said user group taken against the content feature for the whole interest of the user group, which attitude includes compromise, non-compromise and indifference.

7. The method as claimed in claim 5, wherein the step (c) comprises the following steps:
(c1) adjusting said user weight according to said compromise index so as to acquire the adjusted user weight; and
(c2) adjusting said like-degree according to said adjusted user weight, so as to acquire the like-degree of each user for said content feature after said adjustment.

8. An apparatus for acquiring a common interest-degree of a user group for a program, each user in the user group corresponding to a user profile, the apparatus comprising:
receiving means for receiving a program, which contains at least one content feature;
acquiring means for acquiring a like-degree, compromise index and user weight of each user for said content feature from the user profile of the user;
adjusting means for adjusting the like-degree of the user for said content feature in combination with the user weight and compromise index of each user; and
common interest-degree analyzing means, for acquiring the common interest-degree of the user group for the program according to the adjusted like-degree.

9. The apparatus as claimed in claim 8, the adjusting means further comprises:
first-adjusting means for adjusting said user weight according to said compromise index so as to acquire the adjusted user weight; and
second-adjusting means for adjusting said like-degree according to said adjusted user weight so as to acquire the like-degree of each user for said content feature after said adjustment.

10. An apparatus for recommending information to a user group, in which group each user corresponds to a user profile, the apparatus comprising:
receiving means for receiving a program, which contains at least one content feature;
acquiring means for acquiring a like-degree, compromise index and user weight of each user for said content feature from the user profile of the user;
adjusting means for adjusting the like-degree of the user for said content feature in combination with the user weight and compromise index of each user; and
common interest-degree analyzing means, for acquiring the common interest-degree of the user group for the program according to the adjusted like-degree;
recommending means for deciding whether to recommend the common interest-degree of the user group for the program.

11. The apparatus as claimed in claim 10, the adjusting means further comprises:
first-adjusting means for adjusting said user weight according to said compromise index, so as to acquire the adjusted user weight; and
second-adjusting means for adjusting said like-degree according to said adjusted user weight so as to acquire the adjusted like-degree of each user for said content feature after said adjustment.
